(19) United States
(12) Patent Application Publication
(10) Pub. No.: US 2026/0211635 A1
(43) Pub. Date: Jul. 23, 2026

(54) EFFICIENT NOTEBOOK TO PRODUCTION CODE CONVERTER VIA LARGE LANGUAGE MODELS

(71) Applicant: Oracle International Corporation, Redwood Shores, CA (US)

(72) Inventor: Constantin Nicolae, Zurich (CH)

(21) Appl. No.: 19/032,629

(22) Filed: Jan. 21, 2025

(51) Int. Cl. G06F 8/35

(52) U.S. Cl. CPC G06F 8/35

(57) ABSTRACT

Generative natural language processing (NLP) and source logic refactoring by large language models (LLMs) are deferred until interactively-initiated deployment of a Python notebook. The deployment is interactively initiated from a Python kernel in a computer. An LLM inferentially detects many extraneous cells in an original sequence of cells in an original Python notebook. An LLM inferentially generates a modified copy of the original Python notebook. For each extraneous cell, the extraneous cell is excluded from representation in the modified notebook based on a cell type of the extraneous cell. New subroutines are generated and included in the modified notebook. Differential tests and natural language for reference documentation are inferentially generated for the modified notebook.

### FIELD OF THE INVENTION

Generative natural language processing (NLP) and source logic refactoring by large language models (LLMs) are deferred until interactively-initiated deployment of a Python notebook.

### BACKGROUND

Data scientists commonly use an interactive notebook logic environment for exploratory data analysis and preliminary machine learning model development. Such environments are well-suited for experimentation and rapid prototyping, allowing data scientists to quickly iterate on ideas, visualize data, and test hypotheses. However, the code within these notebooks is often cluttered with extensive debugging information, temporary variables, ad-hoc analysis, and a myriad of visualizations that serve exploratory purposes rather than production needs. Moreover, the code typically lacks the necessary structure, modularity, and documentation required for a production environment.

One challenge is debugging artifacts. Exploratory notebooks are often filled with print statements, temporary variables, and experimental code snippets that serve as quick checks during analysis. These debugging artifacts, while useful for exploration, are unsuitable for production environments. They clutter the codebase, reduce readability, and can introduce unnecessary complexity if not removed before deployment.

Another challenge is a lack of documentation. Code written in notebooks typically focuses on speed and exploration rather than clarity and maintainability. As a result, it often lacks proper documentation, including comments, explanations of logic, and usage instructions. This absence of documentation makes it challenging for other developers to understand the code, leading to difficulties in maintenance, collaboration, and scaling.

Testing deficiencies are a challenge. Notebook environments are primarily designed for iterative exploration, where quick experimentation takes precedence over rigorous testing. This lack of testing increases the risk of introducing errors when the code is moved to production, because untested or inadequately tested code might fail under different conditions or when integrated with other systems.

Inconsistent code quality is a challenge. Production environments demand consistent code quality, including adherence to coding standards, style guides, and best practices. However, in exploratory notebooks, these standards are often neglected in favor of rapid iteration. The result is code that may be poorly structured, inconsistently formatted, and difficult to integrate with other parts of the codebase. This inconsistency can lead to technical debt, making future enhancements and maintenance more challenging and error-prone.

Code generative automation may be unhelpful due to technical challenges. For example, generated logic might be defective, cryptic (i.e. incomprehensible by a person), and unmaintainable. Due to the unstructured nature of notebooks and the absence of formal code reviews during exploration, manual transformational deployment is not only time-consuming but also prone to introducing errors, making the process both challenging and resource-intensive.

Code generation by large language models (LLMs) is an active line of research, and there exists a wide range of models in different capacities, accuracies, and capabilities to intelligently infer new logic. As follows, state of the art learned generation of code may be inaccurate, which is a technologic problem. Herein, bidirectional encoder representations for transformers (BERT) and generative pretrained transformer (GPT) are interchangeable or equivalent opensource implementations of a general-purpose LLM that is a pretrained deep neural network (DNN) for natural language (NL) processing (NLP). An LLM is a powerful language model that may rely heavily on the structure and patterns of NL to understand and process meaningful text. Diction and phrasing, being the arrangement of words and phrases in a sentence, significantly affect an LLM's accuracy for the following reasons.

An LLM's contextual comprehension may be affected by semantics such as dependency relationships between words in an NL prompt that the LLM accepts as input. The LLM learns how words relate to each other syntactically, which aids in comprehension of the overall meaning of a sentence. For example, recognizing a subject-verb-object structure helps the LLM infer causes and effects. Syntactic information provides structural clues that help the LLM disambiguate words with multiple meanings by considering the context in which a word is used.

The accuracy of an NL prompt may be measured by measuring the accuracy of an inference from the prompt. That is, natural language may be measurably inaccurate. For example, the accuracy of generated NL is measurable.

The following are supervised (i.e. labeled) and unsupervised ways of measuring accuracy of generated NL. With a labeled dataset, it is possible to measure NL accuracy quantitatively with the following various NL metrics, including metrics similar to Factuality that measures how much of the generated NL is relevant (i.e. signal, not noise). The following are automatic ways to measure accuracy of prose.

Bilingual Evaluation Understudy (BLEU) has a scale from 0 to 1 where 0 corresponds to complete inaccuracy and 1 to perfect accuracy. The score is calculated based on the number of matching n-grams (multiword short phrases) using a modified n-gram precision and a brevity penalty to prevent biases.

Recall-Oriented Understudy for Gisting Evaluation (ROUGE) is a set of metrics for comparing the desired output and the reference. It measures the longest matching sequence of words in the two texts.

MPNet measures similarity between two pieces of text as cosine similarity of embedding vectors that represent the text.

The AlignScore metric uses a tuned Robustly Optimized BERT Pretraining Approach (ROBERTa) and a function on the output of the model to output a score between 0 and 1 representing the alignment of two strings of text. This approach is different from the others because it uses an LLM. It uses the embeddings (a compressed representation of the sentence) given as output from the ROBERTa language model.

By the above example accuracy metrics, accuracy of any NL generated herein may be quantified, and this accuracy is a performance measurement of an LLM that generated the NL and a performance measurement of internal operation of a computer that hosts the LLM.

### BRIEF DESCRIPTION OF THE DRAWINGS

In the drawings:

FIG. 1 is a block diagram that depicts an example computer in which generative natural language (NL) processing (NLP) and source logic refactoring by agent large language models (LLMs) are deferred until deployment of an original Python notebook is interactively initiated;

FIG. 2 is a block diagram that depicts an example agents pipeline that performs generative NLP and source logic refactoring that is deferred until deployment of an original Python notebook is interactively initiated;

FIG. 3 is a block diagram that depicts an example comprehension agent that inferentially analyzes an original Python notebook;

FIG. 4 is a block diagram that depicts an example planning agent that inferentially strategizes such as by detecting so-called code smells that are accidental patterns of logic that indicate suboptimal processing;

FIG. 5 is a block diagram that depicts an example transformation agent that inferentially refactors and inferentially generates logic;

FIG. 6 is a block diagram that depicts an example validation agent that inferentially generates differential tests;

FIG. 7 is a flow diagram that depicts a computer process in which some stages of an agents pipeline cooperatively and inferentially generate a modified copy of a Python notebook;

FIG. 8 is a flow diagram that depicts a computer process in which some stages of an agents pipeline cooperatively test, commit, and deploy a modified copy of a Python notebook according to a software development lifecycle (SDLC);

FIG. 9 is a block diagram that illustrates a computer system upon which an embodiment of the invention may be implemented;

FIG. 10 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein, generative natural language processing (NLP) and source logic refactoring by large language models (LLMs) are deferred until interactively-initiated deployment of a Python notebook. This approach addresses a critical challenge in data science workflows, which is transitioning code from exploratory notebook environments to production environments. In this approach, LLMs facilitate the transformation of notebook code to production-ready code. By integrating with version control systems, such as Git, the system automates the process of code cleanup, formatting, documentation, testing, and integration, which significantly increases reliability required for production deployment.

The system herein connects directly to version control repositories and uses LLMs to parse, understand, and transform the notebook code according to the standards and requirements of the production environment. This approach introduces several novel features that significantly enhance the efficiency, accuracy, and automation of converting exploratory notebook code to production-ready code using LLMs. These innovations address key challenges in data science workflows and provide a robust, scalable solution for seamless transformational deployment.

Innovative LLM-driven code transformation includes context-aware code parsing. The system utilizes LLMs to deeply understand and categorize notebook cells based on their purpose, such as data preprocessing, model training, or visualization. This context-aware parsing enables accurate restructuring of code into production-compatible modules.

Innovative planning of logic refactoring leverages LLMs trained on software engineering tasks. The system automatically refactors notebook code by removing debugging artifacts and restructuring the code into reusable, modular components. This decreases manual effort and minimizes errors during a transformational deployment.

Integrated documentation and test generation includes automatic documentation creation. The system generates comprehensive documentation, including Python docstrings (i.e. function annotations) and inline comments directly from the code's structure and logic to ensure consistency with project guidelines. This automated documentation is contextually accurate to enhance code maintainability.

For test suite generation, the LLM automatically generates unit and integration tests based on the code's logic, critical paths, and edge cases. These tests are created in alignment with an application's continuous integration (CI) or continuous deployment (CD) pipeline, ensuring that the code is thoroughly validated before deployment.

Adaptive code formatting and integration includes dynamic formatting of Python logic. The system applies project-specific coding standards dynamically, using LLM-driven formatting tools. This ensures that the transformed code adheres to style guides such as Python enhancement proposal 8 (PEP8), reducing the need for manual code reviews.

For seamless code integration, the LLM adapts the newly transformed code to fit within the existing project architecture, handling dependency injection, module imports, and conflict resolution. This feature ensures that the code integrates smoothly into the broader codebase. For manual review assistance, the LLM generates a checklist for reviewers, highlighting areas that may need manual verification or intervention, thus enhancing the efficiency and accuracy of the review process.

This approach has automated pull request (PR) management and LLM-generated PRs. The system automatically generates detailed PR descriptions, including summaries of changes, rationale, and links to generated tests. This also tags the PR with metadata, streamlining the review process.

End-to-end workflow automation within a notebook interface includes single-click conversion in notebooks. The entire conversion process is implemented directly within the notebook interface, allowing users to interactively trigger the transformation of their code into production-ready code with a single click. This integration within the familiar notebook environment streamlines the workflow, providing immediate feedback and seamless operation without requiring the user to leave the notebook interface. For interactive conversion feedback as the system processes the notebook, this approach provides real-time feedback and progress updates within the interface, allowing data scientists to monitor an ongoing transformational deployment and intervene if necessary. This feature enhances user control and ensures transparency throughout the conversion process.

These features collectively represent a qualitative advancement in the automation of code transformation within a notebook environment. By integrating the entire process into the notebook interface, the system offers a user-friendly, efficient, and intelligent solution that reduces manual workload, enhances code quality, and ensures smooth integration into production environments. Interpreting exploratory notebooks to accurately derive their intended functionality is a complex challenge. Notebooks often contain unstructured code, lack comprehensive documentation, and include debugging artifacts that obscure the core logic. To overcome these challenges, the system has an agent-based architecture that leverages LLMs in conjunction with specialized software agents. This architecture ensures a deep understanding of the code's intent and facilitates precise transformation into production-ready code while preserving the original functionality.

### 1.0 Example Computer

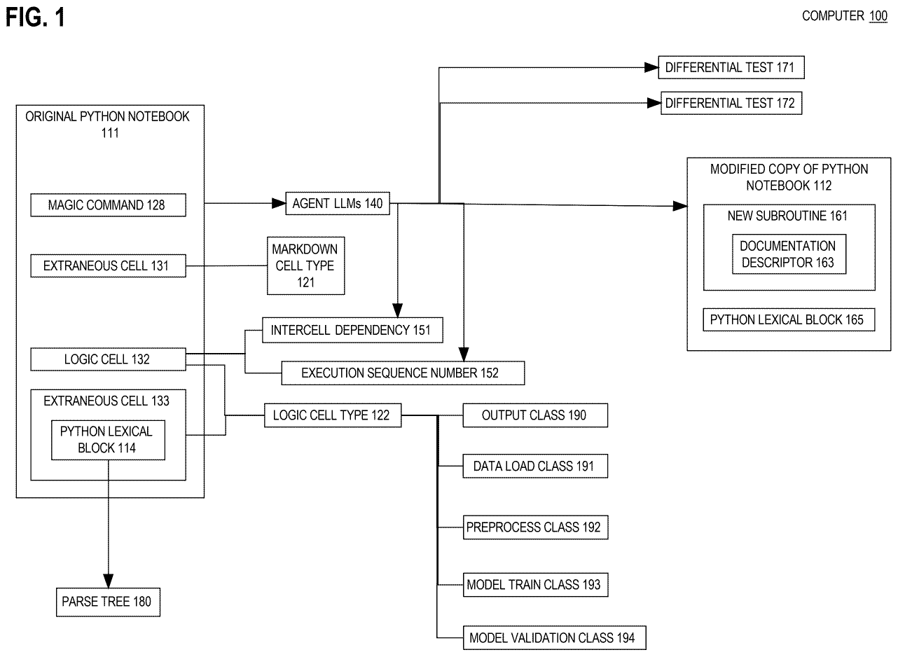

FIG. 1 is a block diagram that depicts an example computer 100 in which generative natural language (NL) processing (NLP) and source logic refactoring by agent large language models (LLMs) 140 are deferred until deployment of original Python notebook 111 is interactively initiated. Computer 100 may be one or more computers such as a rack server such as a blade, a personal computer, a mainframe, or a virtual computer. All of the shown components may be respectively stored and operated in volatile or nonvolatile storage of computer 100.

Original Python notebook 111 contains multiple notebook cells 131-133 that contain or consist of text. In an embodiment, original Python notebook 111 is a text file that consists of JavaScript object notation (JSON) that defines notebook cells 131-133. In an embodiment, original Python notebook 111 is a .ipynb file that is accepted by either or both of Google Colab and opensource Jupyter.

### 1.1 Many Logic Cells in Python Notebook

Original Python notebook 111 may contain many logic cells, including logic cell 132, that contain imperative source logic. For example, logic cell 131 may contain Python statement(s), and execution of logic cell 131 entails execution of those Python statements.

Each of notebook cells 131-133 effectively is a JSON dictionary consisting of key-value pairs. The following example logic cell 132 contains two Python statements. Here are the two Python statements.

my_list=[1, 2, 3]
my_list

In the following example logic cell 132, is array field ‘source’. The ‘source’ array has two elements, each of which is a distinct one of the above two Python statements.

```
{
    ″cell_type″: ″code″,
    ″execution_count″: 1,
    ″metadata″:  { },
    ″outputs″: [ {
        ″output_type″: ″execute_result″,
        ″data″: {
        ″text/plain″: ″[1, 2, 3]″
        },
        ″metadata″: { },
    } ],
    ″source″:  [ ″my_list =  [1, 2, 3]\n″, ″my_list″ ]
}
```

All fields in above example logic cell 132 are metadata except for the ‘source’ field. For example, field ‘execution_count’ is metadata. Although metadata fields of a logic cell have important diagnostic and analytic purposes, metadata fields of a logic cell are not needed to execute the logic cell in a production environment. In ways herein, computer 100 inferentially transforms original Python notebook 111 to generate modified copy of Python notebook 112. This transformation is not required to propagate all metadata from original Python notebook 111 into modified copy of Python notebook 112. As discussed later herein, this transformation may: a) modify metadata that is propagated from original Python notebook 111 to modified copy of Python notebook 112 and b) generate and include new metadata into modified copy of Python notebook 112.

Although original Python notebook 111 is JSON, modified copy of Python notebook 112 instead is a pure Python script. If above example logic cell 132 is the only logic cell in original Python notebook 111, then modified copy of Python notebook 112 may be a Python script that is logically equivalent to above example logic cell 132. Logical equivalence is possible herein even if field ‘source’ is the only cell field represented in modified copy of Python notebook 112, and even if modified copy of Python notebook 112 contains only the above two Python statements. However herein, modified copy of Python notebook 112 contains or is accompanied by additional text that is generatively inferred by agent LLMs 140 to facilitate the full software development lifecycle (SDLC) of original Python notebook 111, even though some or all of this additional text may be unneeded to execute modified copy of Python notebook 112.

As discussed later herein, a notebook agent is a software process hosted by computer 100 or a remote computer, and an agents pipeline consists of a sequence of multiple notebook agents. Herein, a notebook agent is a software agent that analyzes, plans, or generates a Python notebook. If two notebook agents share a same address space in a same computer, then the agents may, for example, use distinct prompt templates to generate prompts for a same shared LLM. Likewise, a notebook agent may use multiple distinct LLMs, some shared with collocated notebook agents and some not shared.

### 1.2 Many Extraneous Cells in Notebook

Extraneous cells 131 and 133 are not represented in modified copy of Python notebook 112. However herein, some extraneous cells may contribute or influence content in the additional text that is generatively inferred by agent LLMs 140. All markdown cells are extraneous. Each cell has a respective cell type, and markdown cell type 121 is the cell type of all markdown cells, including extraneous cell 131. Logic cell type 122 is the cell type of all logic cells, including logic cells 132-133 even though cell 133 is extraneous as discussed later herein. In above example logic cell 132, ‘code’ is logic cell type 122. Markdown cell type 121 is ‘markdown’ in the following example extraneous cell 131.

```
{
  “cell_type”: “markdown”,
  “metadata”: { },
  “source”: [ “# This cell is part of a Jupyter Notebook” ]
}
```

### 1.2 Discovering Predefined Types of Notebook Cells

Herein, cell types are predefined and mutually exclusive. In an embodiment, all cell types also are standard and common to (i.e. compatible with) Google Colab and opensource Jupyter. As discussed later herein, one of agent LLMs 140 inferentially classifies each of logic cells 132-133 as a respective one of mutually-exclusive logic classes 190-194. In an embodiment, one of agent LLMs 140 may accept a linguistic prompt (not shown) as an input that is text. The linguistic prompt may contain original Python notebook 111 and output of shell commands applied to: original Python notebook 111 or an individual notebook cell. Herein, any linguistic prompt may consist of a sequence of prompt parts. Each prompt part is (e.g. generated or predefined) text, and aggregation of parts entails textual concatenation of the parts.

In one example, a shell command may contain a regular expression (regex), and the shell command may generate text that indicates that Python logic in extraneous cell 133 ends with a .show( ) function invocation. In that case, one of agent LLMs 140 may inferentially classify extraneous cell 133 as output class 190. In an embodiment, all logic cells classified as output class 190 are treated as extraneous and not represented in modified copy of Python notebook 112.

That is, some logic cells are treated as output cells even though Google Colab and opensource Jupyter do not have logic cell classes and do not distinguish an output cell. Thus, excluding output cells is a form of logic compression and logic acceleration that decreases the size and complexity of modified copy of Python notebook 112. For example, modified copy of Python notebook 112 can later be executed in a headless environment that does not have a user interface.

### 1.3 Different Kinds of Inferred Refactoring of Notebook Logic

Excluding output cells is one example of refactoring that is inferentially performed in agent LLMs 140, and this is a semantic refactoring. Syntactic refactoring is also inferred. For example, magic command 128 may occur in some of notebook cells 131-133 or elsewhere in original Python notebook 111. The IPython kernel is a Python kernel that is used by both of Google Colab and opensource Jupyter. IPython supports standard Python statements and magic commands that are not Python statements.

Depending on the embodiment, a magic command is: a) an IPython command, b) a command that is not a Python statement, or c) a command that requires Google Colab or opensource Jupyter. Either of inferred logics 161 or 165 may contain or consist of Python logic statement(s) that implement magic command 128. That is, one of agent LLMs 140 already was supervised trained to translate magic commands into Python logic in modified copy of Python notebook 112. Thus, modified copy of Python notebook 112 is a standard (i.e. pure) Python script whose execution would not require Google Colab or opensource Jupyter.

One learned syntactic refactoring that can generate new subroutine 161 is function extraction (i.e. generation). A first kind of function extraction converts, for logic compression, duplicate logic in original Python notebook 111 into invocations of new subroutine 161. A second kind of function extraction decomposes into multiple smaller functions, for readability (i.e. human comprehensibility) as discussed later herein, a function whose body exceeds a threshold maximum such as: a) a count of contained Python statements or b) as discussed later herein, a cyclomatic complexity.

New subroutine 161 may contain annotations (i.e. metadata) that contain inferentially generated NL that describes new subroutine 161, such as documentation descriptor 163 that is text that contains a mix of NL and inferred occurrences of standardized tags that a logic documentation generator would understand. For example, documentation descriptor 163 may be a Python documentation string (docstring). Docstrings may be inferred and inserted into existing functions in original Python notebook 111 that originally lack docstrings.

One learned semantic refactoring is variable renaming in which longer and more meaningful (i.e. self descriptive) names are inferred for some function parameters, local variables, and global variables. Another learned semantic refactoring is dead code elimination. For example, partial evaluation may reveal that some Python statements, Python lexical blocks, or logic cells are unreachable and should not be represented in modified copy of Python notebook 112. One of agent LLMs 140 can inferentially detect an execution ordering sequence of logic cells if original Python notebook 111 were executed. For example and without executing original Python notebook 111, execution sequence number 152 is inferred metadata that indicates the position of logic cell 132 in the execution ordering sequence.

### 1.4 Inferred Test Cases for Notebook Logic

Semantic refactoring is not the only learned way of agent LLMs 140 in which notebook semantics guide generative inferencing. Based on semantics in original Python notebook 111, agent LLMs 140 inferentially generate multiple differential tests 171-172. In an embodiment: a) original Python notebook 111 is a next (i.e. new) version of an original Python notebook, and b) before receiving original Python notebook 111, computer 100 already generated and retained a previous version of modified copy of Python notebook 112 from a previous version of original Python notebook 111. In an embodiment, computer 100 can retrieve a previous version or commit a next version of modified copy of Python notebook 112 in a first version control repository, even if computer 100 has no commit privilege or no access to a second version control repository that contains original Python notebook 111.

Execution of each of differential tests 171-172 entails execution of the previous and next versions of modified copy of Python notebook 112 and comparison of results between both versions. Only if both versions generate equivalent results, the differential test passes. Pass or fail of each of differential tests 171-172 is displayed to the user and, in an embodiment if all differential tests 171-172 have passed, then the user is asked for interactive approval before modified copy of Python notebook 112 is: a) committed into version control and b) deployed and executed in a production environment.

In an embodiment, a sequence of multiple interactions from the user is needed. For example, generation of modified copy of Python notebook 112 may be initiated by interactively pressing a displayed pushbutton that is labeled “Move To Production”, where Move means deploy. First, the user presses this button to cause logic generation, and then the user views the test results and interactively agrees that actual deployment of the already generated logic may begin. Each of logic generation, logic testing, and logic deployment entails displaying ongoing progress status to the user, including some low verbosity natural language. If the user notices unsatisfactory or unexpected natural language in the displayed status, then the user may interactively cancel all ongoing processing, including any remote processing.

### 2.0 Example Agents Pipeline

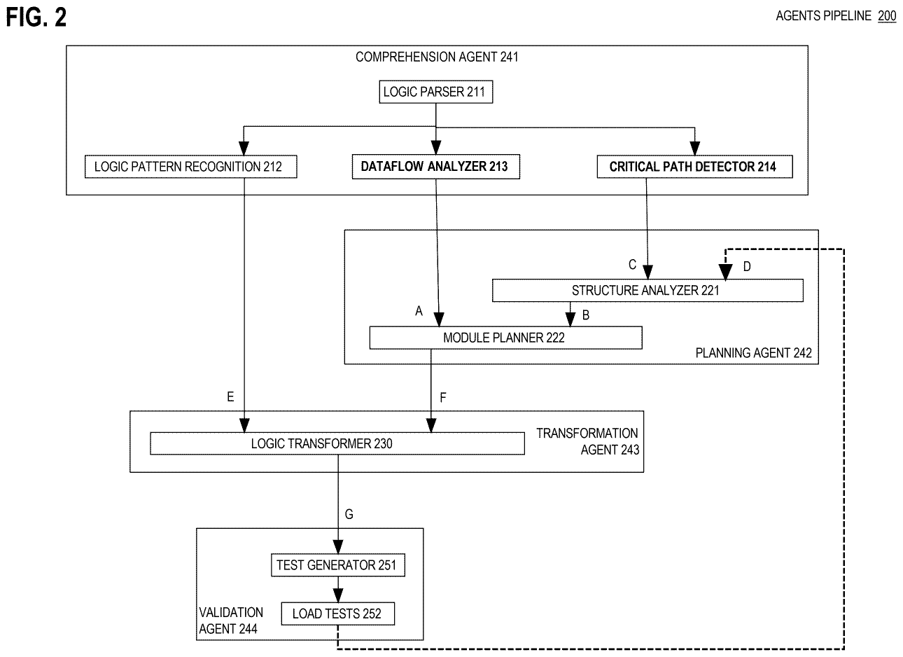

FIG. 2 is a block diagram that depicts example agent large language models (LLMs) 140 that perform generative natural language (NL) processing (NLP) and source logic refactoring that is deferred until deployment of original Python notebook 111 is interactively initiated. Agent LLMs 140 are contained in respective notebook agents 241-244 that each is distinctly specialized in the following ways. Notebook agents 241-242 are analytic, and notebook agents 243-244 are logic generative.

Each of notebook agents 241-244 contains or shares at least one LLM (not shown). In a compact embodiment, an LLM may be shared by some or all of agents 241-244. In some embodiments: a) agents 241-244 share a single address space, and/or b) agent LLMs 140 has only a single (i.e. shared) LLM. In a decoupled embodiment, no LLM is shared by multiple agents. In an embodiment, each of agents 241-244 may have its own address space, virtual machine (VM), or network element such as a computer.

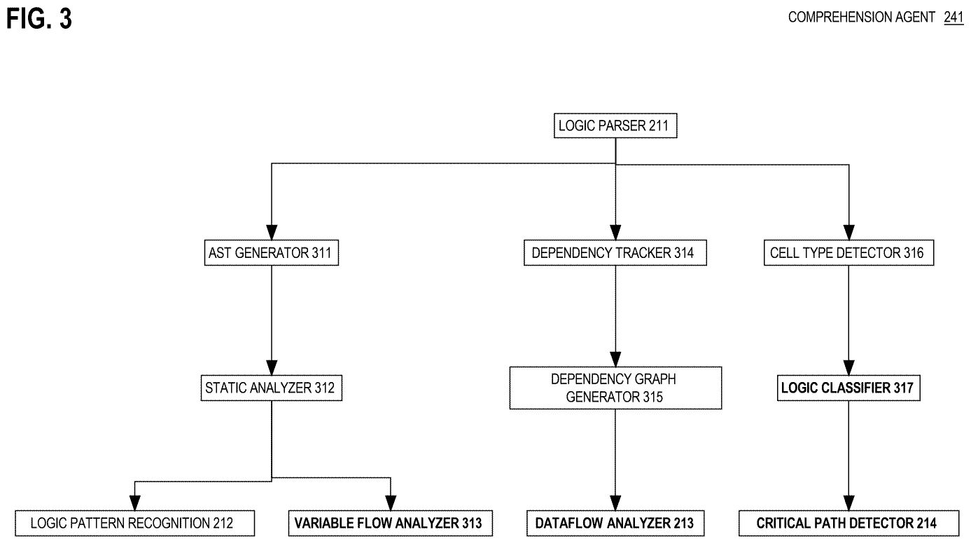

Components 213-214 are shown bold to indicate that they are directly implemented by a same LLM or respective LLMs. In FIGS. 2-6, components shown bold are referred to as LLM components because they are directly implemented by an LLM. Although multiple LLM components may or may not share a same LLM, each LLM component requires its own distinct linguistic prompt and performs its own distinct inference. For example even if components 213-214 share an LLM, one invocation of comprehension agent 241 causes generation of two distinct linguistic prompts and causes two distinct inferences by that LLM. Although FIG. 2 shows only two LLM components 213-214 in comprehension agent 241, FIG. 3 discussed later herein shows that comprehension agent 241 contains four LLM components, which would entail four distinct linguistic prompts and four distinct inferences, regardless of whether comprehension agent 241 has one or multiple LLMs.

Herein even if multiple LLM components are combined into one LLM, each of the multiple LLM components has its own specialized training task by which the LLM was already supervised trained. In an embodiment, there is a one-to-one correspondence between distinct LLM components and distinct prompt templates for generating linguistic prompts that the LLM accepts.

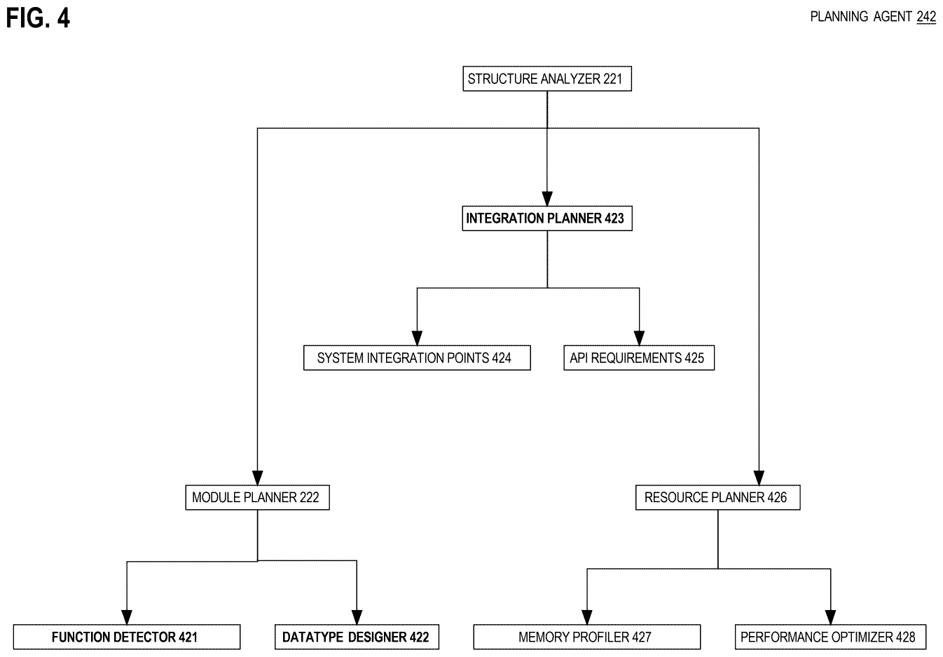

FIG. 2 depicts agents pipeline 200 that shows some of agent LLMs 140 and that emphasizes dataflow between notebook agents 241-244. Although not shown in FIG. 2, each of notebook agents 241-244 contains additional components that are shown in FIGS. 3-6 as discussed later herein. Components 211-212, 221-222, 230, and 251-252 are shown nonbold to indicate that each may or may not contain or share an LLM but, if so, the LLM is only a part of the component as discussed later herein. For example in FIG. 2, notebooks agents 242-244 are shown containing only nonbold components, but FIGS. 4-6 show that notebook agents 242-244 do contain LLM components. In FIGS. 2-6, each LLM component accepts a respective linguistic prompt as input, and components shown nonbold do not accept a linguistic prompt as input.

Most of the arrows in FIG. 2 are vertical and downwards to indicate dataflow between notebook agents 241-244 and to indicate some of the dataflow inside notebook agents 241-242 and 244. That is, FIG. 2 shows a vertical pipeline that proceeds downwards, which is referred to herein as agents pipeline 200. Each of notebook agents 241-244 is a stage in the sequence of stages in agents pipeline 200. As discussed below, agents pipeline 200 may iterate (i.e. repeat) over notebook agents 242-244, but comprehension agent 241 operates only (i.e. once) before iteration as follows.

Comprehension agent 241 analyzes original Python notebook 111 as discussed later for FIG. 3. Comprehension agent 241 accepts original Python notebook 111 as input from which logic parser 211 generates one or many parse trees (not shown). Logic parser 211 contains a JavaScript object notation (JSON) parser that extracts, into JSON notebook cells 131-133, from original Python notebook 111. For example to represent original Python notebook 111, the JSON parser may generate a parse tree that consists of nested Python dictionaries or a document object model (DOM).

Logic parser 211 contains a Python parser that can generate a separate abstract syntax tree (AST) for each of logic cells 132-133 or can generate a single monolithic AST that represents all logic cells 132-133. An AST is a parse tree that represents part or all of original Python notebook 111 in a format that facilitates learned semantic analysis. In an embodiment, an AST is a directed acyclic graph (DAG) instead of a logical tree. A parse DAG is referred to herein as an abstract semantic graph (ASG), where nodes represent functions, variables, or data operations, and edges represent relationships or dataflows between nodes.

Each of analytic components 212-214 may accept an input that contains either or both of a JSON parse tree and a Python ASG. In an embodiment: a) for memory saving and for increased inferential accuracy, a lossy-compressed representation of an AST consists of implementation-dependent fixed-length tree traversal paths such as paths terminating at leafs (i.e. leaves) or other n-grams, b) a vocabulary may be predefined as the most frequent n-grams in a corpus of multiple original Python notebooks, c) each vocabulary n-gram may be a bin in a logical (i.e. not visual) histogram that represents an AST, and d) an AST histogram may be inserted into a linguistic prompt or provided as input to a component.

As discussed earlier herein, a regular expression (regex) in logic pattern recognition 212 may detect: a) Python lexical block 114 in extraneous cell 133 ends with a Python statement that is a .show( ) function invocation, in which csse b) extraneous cell 133 has output class 190. Logic pattern recognition 212 may apply regex(s) to categorize and detect cells of a same cell type and especially of logic cell type 122. In some cases, logic pattern recognition 212 can tentatively (i.e. preliminarily) classify a logic cell as one of logic cell classes 190-194. However, accurate (i.e. final) classification with logic cell classes 190-194 requires analysis of dependencies and flow by components of FIGS. 3-4 as discussed later herein.

A logic cell may define a Python function that another logic cell invokes. That is, a call site of a function and the definition of the function may be in separate logic cells. Dataflow analyzer 213 detects dataflow between logic cells, including: a) detecting which logic cells share which global Python variables, including which logic cell writes a global variable and which logic cell reads the global variable and b) mapping each argument from a calling logic cell to a function parameter in a called logic cell. In an embodiment, logic cell(s) that write variables only read by logic cells of output class 190 may themselves be reclassified as output class 190. Thus, a logic cell that does not itself perform output may nonetheless be classified as output class 190.

Each logic cell in original Python notebook 111 has a distinct purpose, and some logic cells are specialized for error handling or boundary (i.e. unusual) conditions. That is, some logic cells may be conditional such that they execute only if a special condition occurs. Herein, a happy path is a maximal sequence of logic cells that would execute if original Python notebook 111 would execute successfully. As detected by critical path detector 214, herein a critical path is a minimal (i.e. subset of the happy path) sequence of logic cells that would execute if original Python notebook 111 would execute without any boundary conditions. A critical path may be included in a linguistic prompt to cause inferential generation of a so-called smoke test that exercises the critical path, and successful smoke testing may be a prerequisite before other kinds of testing. Generation and execution of tests of different kinds are discussed later herein.

Structure analyzer 221 accepts input C that contains a critical path. By delegation to components in FIG. 4, structure analyzer 221 plans (i.e. selects) all implementation strategies needed to inferentially generate logic components 112 and 171-172 as discussed later herein. Modified copy of Python notebook 112 is not a single Python file, but instead contains multiple inferentially generated Python . py text files. Herein: a) each Python file is referred to as a Python module or a Python script; b) execution of an import statement in one module causes loading and executing another module; and c) a module or a logic cell may contain multiple import statements. To represent original Python notebook 111 as discussed later herein, comprehension agent 241 may generate a dependency graph (not shown) in which an edge may connect to vertices that may be: a) two logic cells or b) a logic cell and a preexisting (i.e. not generated) module. Comprehension agent 241 may annotate the edges in the dependency graph to generate a dataflow graph that indicates what data is transferred from one vertex to another based on an edge.

Module planner 222 has LLM components in FIG. 4 that inferentially select ways to refactor original Python notebook 111 such as: a) extracting, reifying, or centralizing logic of shared (i.e. repeated) behavior and structure, including designing new subroutine (i.e. Python function) 161 and b) partitioning the set of logic cells and new subroutines into new subsets (i.e. modules). Module planner 222 does not generate logic and does not apply the refactoring selected. Module planner 222 accepts inputs A-B respectively from components 213 and 221. Input A contains the dataflow graph that is an enhanced dependency graph as discussed above.

As discussed above, comprehension agent 241 classifies logic cells with logic cell classes 190-194. Structure analyzer 221 assigned a respective one of logic cell classes 190-194 to each generated subroutine including new subroutine 161, except subroutines that are shared by logic cells of multiple logic cell classes, and these exceptional subroutines may be combined into one new module by module planner 222. New and existing subroutines of a same logic cell class are combined into a same module by module planner 222. There is one module respectively for each of logic cell classes 190-194. Input B contains a mapping of (e.g. not yet generated) subroutines to respective logic cell class.

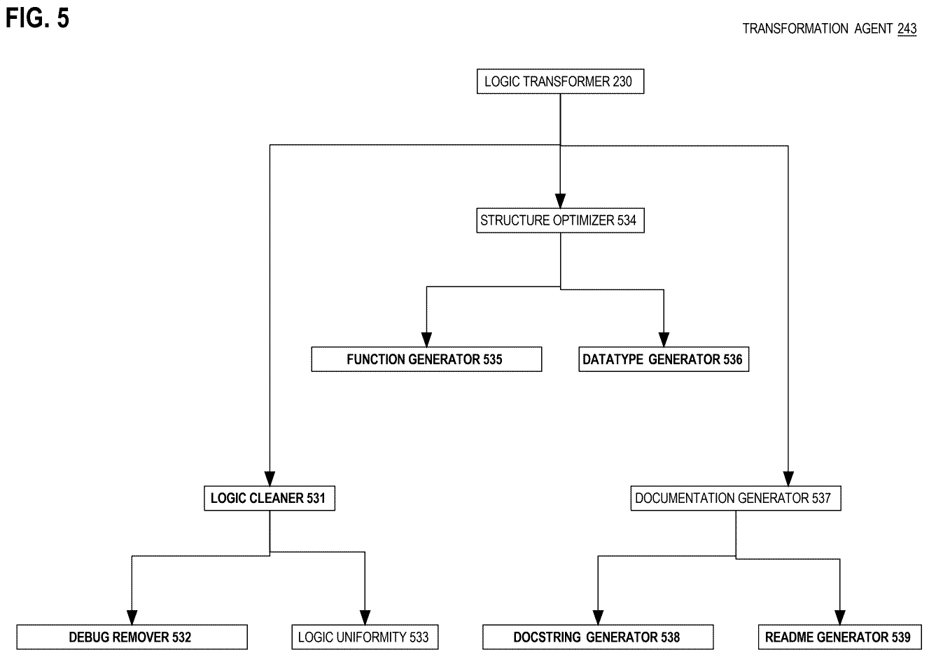

Transformation agent 243 contains logic transformer 230 that has many LLM components shown in FIG. 5 that inferentially generate all of logic components 112 and 171-172. Logic transformer 230 accepts inputs E-F respectively from components 212 and 222. Input E contains a mapping of logic cells to logic cell classes 190-194. Input F contains a respective specification of each selected refactoring to be implemented in modified copy of Python notebook 112 that transformation agent 243 will generate.

Distinct inputs B and F each contains a distinct generatively inferred plan from which Python logic may later be further inferred. Each of inputs B and F may be referred to as a logic plan and may consist of natural language (NL) that summarizes logic in a distinct way such as follows. A logic plan does not contain logic. A logic plan instead contains NL that describes inferred requirements or selected refactoring strategies. Herein, a logic plan is declarative, not imperative. Inputs B and F are two kinds of logic plans, and other kinds of logic plans are discussed later herein. Different kinds of logic plans may exist in sequence, with one logic plan of one kind inferentially produced (i.e. derived) by consuming a logic plan of a different kind. Different kinds of logic plans may be complementary and may be concurrently contained in a same input to a same component. For example, a linguistic prompt or component input may contain multiple complementary logic plans that address distinct respective technical concerns. In that way, a composite logic plan may consist of multiple complementary constituent logic plans.

Input B summarizes logic cells that already exist before Python logic is inferentially generated, and input F summarizes logic refactoring that will later occur when Python logic is inferentially generated.

As discussed earlier herein, notebook agents 241-244 are respective sequential stages in agents pipeline 200. For example, planning agents 241-242 are upstream of (i.e. execute before) transformation agent 243 and, in that case, any parts of some or all of upstream inputs A-C may be included in any of downstream inputs E-F. For example, downstream input G may contain parts of any input or data generated herein.

For example, some data in upstream input C may be included in any of downstream inputs B and F-G. For example, critical path detector 214 may detect a critical path that may be included in input B to prevent module planner 222 from merging noncritical logic into the critical path. Likewise, the critical path may be included in input G to cause test generator 251 in validation agent 244 to generate a smoke test as discussed elsewhere herein.

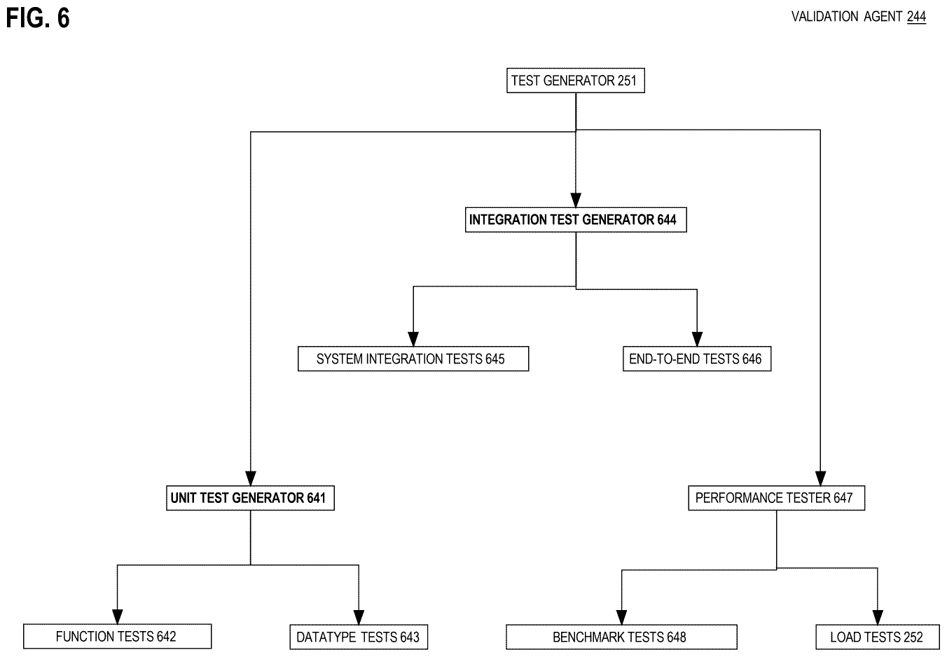

Test generator 251 contains LLM components in FIG. 6 that inferentially generate load (e.g. stress) tests 252 that, when executed, quantitatively measure performance characteristics of execution of modified copy of Python notebook 112. Discussed later herein is failure of any test, including any of load tests 252 or tests of other kinds, and any of these failures would prevent deployment of modified copy of Python notebook 112 into a production environment. For example, modified copy of Python notebook 112 may be logically incorrect or may be logically correct but too slow or demand too much memory or disk space.

If a generated test fails when executed, execution of agents 242-244 may be repeated in a next iteration. If all generated tests pass when executed, then iteration ceases. In a first iteration, structure analyzer 221 accepts input that contains input C but not input D. In subsequent iterations, structure analyzer 221 accepts input that contains both inputs C-D.

Shown with a dashed upwards arrow that indicates a feedback loop, input D is corrective feedback that increases accuracy of components 221-222, 230, 242-244, 251-252, B, and F-G. In each iteration, inputs B, D, and F-G are regenerated, but not inputs A, C, and E that instead are reused as is. Thus, each iteration generates a more or less monotonically better (i.e. more correct or less resource intensive) implementation of logic components 112 and 171-172.

### 3.0 Example Comprehension Agent

FIGS. 3-6 each shows a respective distinct notebook agent and its internal components arranged as nodes in a logical tree in which data flows from the root of the tree downward to the leaves of the tree. Each tree is composed of various subtrees that herein represent both dataflow and a containment hierarchy of internal components.

FIG. 3 is a block diagram that depicts example comprehension agent 241 that inferentially analyzes original Python notebook 111. Components 211-214 and 241 are shown in FIG. 3 and operate as discussed earlier for FIG. 2. LLM components 213-214, 313, and 317 are shown bold to indicate behavior that already was supervised learned.

As discussed earlier herein, logic parser 211 generates a JSON parse tree that represents original Python notebook 111, and components 311, 314, and 316 each accepts a respective input that contains that JSON parse tree. Abstract syntax tree (AST) generator 311 generates a Python parse tree of Python statements in original Python notebook 111 or in a logic cell. Shown downward arrows indicate general dataflow. Some dataflow is implied (i.e. unshown). For example, the generated Python AST may be included in a respective input to each of components 213, 312, and 317. That is although not shown as such, components 213 and 317 may be effectively downstream of AST generator 311.

Static analyzer 312 performs static analysis of the generated Python AST, which does not entail executing the Python statements that the AST represents. Static analyzer 312 delegates to components 212 and 313 to respectively analyze logic (i.e. behavior) or state (i.e. data). Variable flow analyzer 313 may: a) generate a dataflow graph that contains vertices that represent inputs and local variables of an individual logic block and b) for logic compression and logic acceleration, detect that some variables should be removed by i) inlining if read only once or ii) commenting out if read only for diagnostics or only by extraneous cells.

Dependency tracker 314 detects directed dependencies between pairs of logic cells such as intercell dependency 151, and dependency graph generator 315 generates a dependency graph that represents the dependencies as discussed earlier herein. Cell type detector 316 reads cell types in the JSON parse tree as discussed earlier herein. Logic classifier 317 classifies logic cells 132-133 based on logic cell classes 190-194 as discussed earlier herein. Although not shown as such, logic classifier 317 may be effectively downstream of (i.e. receive data from) components 212-213 and 313.

### 4.0 Example Planning Agent

FIG. 4 is a block diagram that depicts example planning agent 242 that inferentially strategizes such as by detecting so-called code smells that are accidental patterns of logic that indicate suboptimal processing. Components 221-222 and 242 are shown in FIG. 4 and operate as discussed earlier for FIG. 2. LLM components 421-423 are shown bold to indicate behavior already was supervised learned.

Module planner 222 delegates to components 421-422 to respectively analyze logic (i.e. behavior) or structure (i.e. data). Datatype designer 422 selects ways of refactoring that achieve encapsulation of members (i.e. functions and variables, a.k.a. methods and fields), fields aggregation, information hiding, and class hierarchy reification including polymorphism. Datatype designer 422 may plan (i.e. select and customize) multiple abstract datatypes (ADTs) and, later from each ADT, a respective Python class will be inferentially generated by transformation agent 243.

In an embodiment, some logic cells of output class 190 are treated as extraneous. For example in a Python abstract syntax tree (AST), either of components 212 or 312 may detect a standard Python verbosity level expressly identified in a Python statement that invokes Python's standard logger. Per a verbosity threshold, a Python logging statement of insufficient verbosity may be treated as extraneous, as well as any other Python statements or notebook cells whose sole purpose is to provide a value or condition to the Python logging statement.

In an embodiment, some logic cells of output class 190 are treated as non-extraneous and are semantically transformed. For example, a logic cell that displays a graph such as a scatterplot or histogram may be inferentially transformed into Python logic that textually summarizes the graph with statistics or natural language (NL), and that generated Python logic will generate textual console output instead of graphical output.

Function detector 241 detects a subsequence of Python statements that is repeated in one or multiple logic cells. Later, transformation agent 243 will replace those similar subsequences with a respective invocation (i.e. call site) to same new subroutine 161 that may have parameters to accommodate differences in local data in the replaced subsequences. For example, two call sites may provide different arguments (i.e. values) to a same parameter of same new subroutine 161.

Modified copy of Python notebook 112 may have external dependencies such as importing third-party libraries, connecting to external systems such as a database server, or staging or packaging by a third-party deployment or hosting framework such as any of: a continuous deployment (CD) tool, a hypervisor, or a containerization image such as for opensource Docker. Integration planner 423 detects a respective mechanism by which each external system should integrate with modified copy of Python notebook 112. Integration planner 423 may select interfaces such as open database connectivity (ODBC), representational state (REST), or common gateway interface (CGI) and interchange formats such as JavaScript object notation (JSON) or extensible markup language (XML).

Integration planner 423 inferentially discovers components 424-425 and inferentially generates a logic plan that contains natural language (NL) that summarizes how to adaptively generate modified copy of Python notebook 112 to use components 424-425 to integrate with external systems. System integration points 424 are, for example, remote procedure calls (RPCs) or REST endpoints. Application programing interface (API) requirements 425 include application-specific semantic requirements and integration framework/protocol specific requirements such as asynchrony, schema validation of semi-structured content, and content encoding such as multipurpose internet media extension (MIME) types.

Resource planner 426 generates a logic plan that selects and customizes strategies to improve performance characteristics of modified copy of Python notebook 112. Memory profiler 427 selects locations and kinds of instrumentation that, when modified copy of Python notebook 112 later executes, will record memory consumption measurements in a nonintrusive (i.e. low latency) way. Performance optimizer 428 selects software design patterns solely for acceleration such as data parallelism, pipeline parallelism, memo-ization, or lazy evaluation. Directly or indirectly based on the various kinds of NL-encoded logic plans generated by planning agent 242, as follows transformation agent 243 will generate modified copy of Python notebook 112 that is highly accurate (i.e. semantically equivalent to original Python notebook 111) and high performance.

### 5.0 Example Transformation Agent

FIG. 5 is a block diagram that depicts example transformation agent 243 that inferentially refactors and inferentially generates logic. Components 230 and 243 are shown in FIG. 5 and operate as discussed earlier for FIG. 2. LLM components 531-532, 535-536, and 538-539 are shown bold to indicate behavior that already was supervised learned.

Python statements in non-extraneous logic cells in original Python notebook 111 are copied into modified copy of Python notebook 112. This copying of logic by logic transformer 230 entails logic transformations including logic compression by components 531 and 534. Transformer agent 243 is logic generative and operates after analytic agents 241-242 that are natural language (NL) generative instead of logic generative.

Components 212-213 and 317 may detect that some logic cells or some Python statements with a logic cell are diagnostic (i.e. solely for debugging) and do not contribute nondiagnostic functionality. Debug remover 532 excludes debugging logic from modified copy of Python notebook 112.

Logic uniformity 533 is an implementation aesthetic that increases human readability. Because modified copy of Python notebook 112 may eventually be deployed and malfunction, human comprehension of modified copy of Python notebook 112 by a software developer, operations technician, or database administrator (DBA) is effectively a human computer interaction (HCI) ergonomics challenge. Remediation delay is decreased by readability (i.e. comprehensibility) of modified copy of Python notebook 112. By imposing logic uniformity 533 on the inferential generation of modified copy of Python notebook 112, logic cleaner 531 accelerates diagnosis and remediation of a software technical malfunction that might later occur.

Logic uniformity 533 is effectively a superficial coding style. In an embodiment, logic cleaner 531 has already learned and can only use one kind of logic uniformity 533 (i.e. one coding style). In various embodiments, logic uniformity 533 may be undecided until logic cleaner 531 is invoked and different invocations may impose distinct instances of logic uniformity 533. In an embodiment, logic uniformity 533 is dynamically discovered in an example Python script or in original Python notebook 111, and especially even if the existing observable coding style was already inconsistently applied.

Components 531 and 533 may delegate to an external or third-party tool such as opensource tools flake8 and Black. Flake8 detects conformity to Python enhancement proposal 8 (PEP8) style rules. Herein, logic cleaning may be decomposed into a sequence of two phases that are a detection phase followed by a correction phase. Herein, the detection phase may be referred to as linting or checking. Flake8 does not perform correction, and correction is disabled when Black is invoked with the—check command line argument.

In an embodiment during the detection phase, logic transformer 230 may: a) operate before logic cleaner 531, b) from logic uniformity 533 (i.e. code style guidelines), generate arguments in a command line that represents logic uniformity 533, c) by that command line, invoke a detection command for flake8 or Black—check to detect violations of logic uniformity 533, and d) include console output (i.e. text) of the detection command in a linguistic prompt that logic cleaner 531 accepts as input. This linguistic prompt causes logic cleaner 531 to inferentially generate modified copy of Python notebook 112 that: a) remedies any violations indicated in the console output and b) conforms to logic uniformity 533. Thus, flake8 or Black —check may be a preprocessor that generates input for logic cleaner 531.

In an embodiment: a) some kinds of correction are not inferentially performed by logic cleaner 531, b): with these corrections only, the detection phase is deferred until the correction phase, c) with these corrections only, the correction phase post-processes Python logic that was inferentially generated by logic cleaner 531. For example, a post processor may be Black invoked without—check.

Although Black without—check can cosmetically (e.g. indentation) reformat Python statements as raw text, Black lacks syntactic transformation of logic. Logic cleaner 531 can infer syntactic transformations as follows. In an embodiment that decreases cyclomatic complexity in modified copy of Python notebook 112: a) the detection phase entails preprocessing by flake8 to generate input for logic cleaner 531 as discussed above, and b) flake8 contains mccabe that is a subsystem that measures and includes, in flake8's console output, cyclomatic complexity of each function being generated in modified copy of Python notebook 112. This console output causes logic cleaner 531 to split a complicated function into multiple simpler functions.

In an embodiment, logic cleaner 531 or its post processor performs corrections that entail any of: a) for logic compression, removing some Python statements such as duplicative or otherwise unneeded import statements, and b) for readability, reordering Python statements such as sorting import statements by decreasing generality (i.e. increasing specificity). For example, standard library imports should occur before proprietary library imports.

In an embodiment for readability, logic cleaner 531 inferentially performs logic identifier renaming such as inferential detection of multiple words in a purely alphabetic identifier. Logic cleaner 531 may insert an underscore between two adjacent words in an identifier. In an embodiment for readability, logic cleaner 531 inferentially performs Python operator reordering in a Python statement such as reversing a relative ordering of operators ‘not’ and ‘is’. In an embodiment for logic compression, logic cleaner 531 inferentially performs removing some Python token(s) such as ==True.

Based on NL designs from planning components 421-422, function generator 535 and datatype generator 536 respectively inferentially generate functions or datatypes such as Python classes as discussed earlier herein. In an embodiment, logic cleaner 531 operates before structure optimizer 534 operates. Technically only structure optimizer 534, not logic cleaner 531 nor documentation generator 537, is needed to generate modified copy of Python notebook 112 that could execute correctly and could pass all generated tests as discussed later herein. However, components 531 and 537 increase readability of modified copy of Python notebook 112 as discussed earlier herein.

For each function or class member, docstring generator 538 inferentially generates a respective docstring that is a Python comment that contains descriptive metadata that contains NL. A docstring is a logic annotation that is not a Python statement and cannot be executed as logic. Docstrings may later be used to automatically generate multiple webpages that contain reference documentation for modified copy of Python notebook 112. For example, some of the generated reference documentation may be for a generated Python logic artifact, in modified copy of Python notebook 112 and never before seen by a person, such as a new module, function, or class that did not exist in original Python notebook 111.

NL generators 538-539 perform NL summarization that includes one or a few natural sentences or natural paragraphs. NL generators 538-539 respectively generate intrusive (i.e. inside generated Python) and non-intrusive descriptions. Readme generator 539 inferentially generates ReadMe text files that provide an overview of one or multiple generated Python artifacts in modified copy of Python notebook 112. A ReadMe file may contain release notes such as installation requirements or a listing of bug fixes. Any reference documentation generated herein accelerates interactive problem diagnosis and resolution if a generated Python artifact malfunctions in a production environment.

### 6.0 Example Validation Agent

FIG. 6 is a block diagram that depicts example validation agent 244 that inferentially generates differential tests 171-172. Components 244 and 251-252 are shown in FIG. 6 and operate as discussed earlier for FIG. 2. LLM components 641 and 644 are shown bold to indicate behavior that already was supervised learned.

Every test generated herein is: a) custom Python logic and b) a differential test that, as discussed earlier herein, verifies that a previous and next version of modified copy of Python notebook 112 behave identically, except that the next version of modified copy of Python notebook 112 may have fewer software defects. Herein, a unit test may test an interrelated few or an individual generated Python artifact(s) such as a new function, class, or module. Unit test generator 641 inferentially generates differential unit tests 642-643. Function tests 642 test generated Python functions, and datatype tests 643 tests generated Python classes.

As discussed earlier herein, new and existing subroutines of a same logic cell class are combined into a same new Python module by module planner 222 such that each of logic cell classes 190-194 has its own new module. Herein, an integration test may test multiple Python modules. Integration test generator 644 inferentially generates differential integration tests 645-646.

As discussed earlier herein, each of agents 241-244 is a stage in a sequence of stages in agents pipeline 200. System integration tests 645 test multiple Python modules or multiple pipeline stages. End-to-end (a.k.a. steel thread) tests 646 tests the whole pipeline. Unlike unit tests and integration tests, an end-to-end test fails if modified copy of Python notebook 112 is not generated.

As discussed earlier herein, computer 100 can retrieve a previous version or commit a next version of modified copy of Python notebook 112 in a first version control repository, even if computer 100 has no commit privilege or no access to a second version control repository that contains original Python notebook 111. That is: a) Python notebooks 111-112 have separate respective version control repositories; and b) each of Python notebooks 111-112 has its own software development lifecycle (SDLC), and these two lifecycles are tightly coupled as discussed later herein. However as follows and as discussed later herein, these two lifecycles are not identical.

In an unusual example, original Python notebook 111 might lack tests and testing, which is well accommodated herein because neither validation agent 244 nor the approach herein require tests and testing for original Python notebook 111. All testing and test generation herein are instead based on modified copy of Python notebook 112. Python notebooks 111-112 may have separate respective tests and, in an unusual scenario, modified copy of Python notebook 112 can fail an inferentially generated test even if original Python notebook 111 passed all of its own original tests.

### 7.0 Example Notebook Logic Refactoring Process

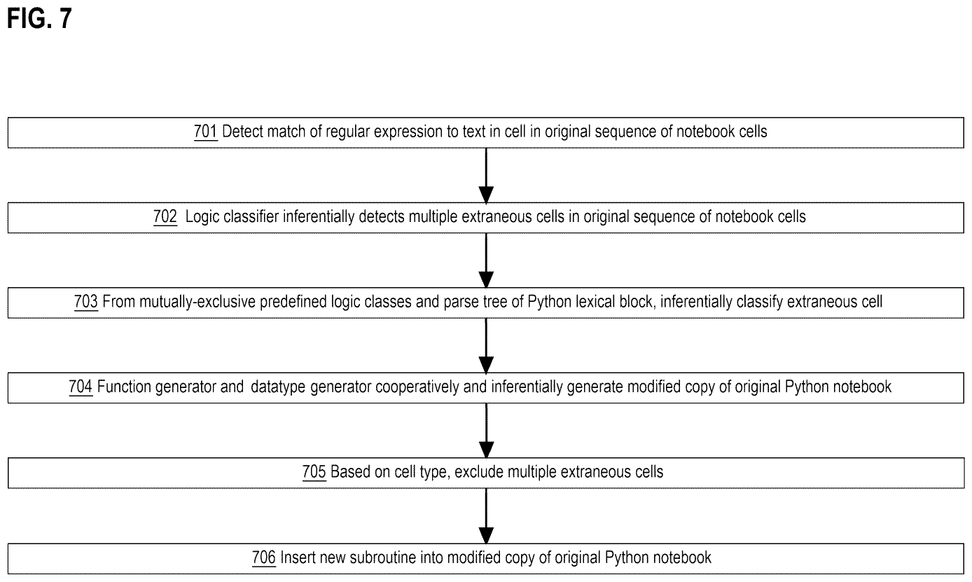

FIG. 7 is a flow diagram that depicts an example process that computer 100 may perform to cause some stages of agents pipeline 200 to cooperatively and inferentially generate modified copy of Python notebook 112.

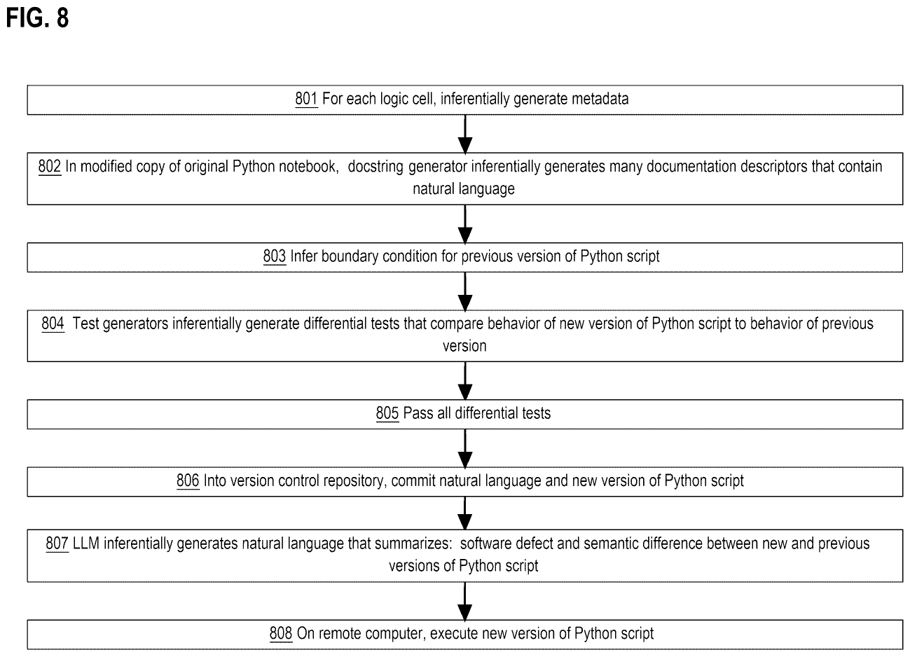

As discussed earlier herein: a) each of agents 241-244 is a stage in a sequence of stages in agents pipeline 200; and b) components 531 and 537 are not needed to generate modified copy of Python notebook 112 that could execute correctly. Likewise, a limited embodiment with less than the whole pipeline may lack validation agent 244. In those ways, the process of FIG. 7 is a streamlined embodiment, and a more capable embodiment would combine some or all of the steps of FIG. 8 with the process of FIG. 7. In an embodiment, a Python kernel detects any interactive trigger herein. In an embodiment, the process of either of FIGS. 7-8 is initiated by the Python kernel in reaction to an interactive trigger, which does not mean that the processes of FIGS. 7-8 execute within the Python kernel. In an embodiment, the Python kernel is contained in a web browser; and agents pipeline 200 is contained in a computer cloud.

As discussed earlier herein cell types are predefined and mutually exclusive and, in an embodiment, all cell types also are standard and common to Google Colab and opensource Jupyter. As discussed earlier herein: a) logic pattern recognition 212 may apply regex(s), during step 701, to the text of a whole notebook cell or to the text of a field in the cell; and b) in that way, step 701 categorizes and detect cells of a same cell type, including cell types 121-122.

As discussed earlier herein: a) logic classifier 317 inferentially classifies logic cells 132-133 based on logic cell classes 190-194; b) dataflow analyzer 213 may cause a logic cell that does not itself perform output to nonetheless be classified as output class 190; and c) partial evaluation may reveal that some logic cells are unreachable. In step 702, logic classifier 317 inferentially detects multiple extraneous cells.

Step 703 is a sub-step of step 702. As discussed earlier herein, a Python abstract syntax tree (AST) of logic cell(s) may be included in a respective input to each of components 213, 312, and 317. All of components 213, 312, and 317 are or contain an LLM component that may infer, from the AST, a categorization, characteristic, or detection about a logic cell.

Multiple smaller Python lexical blocks may be nested in a larger, enclosing Python lexical block. From Python parsing by AST generator 311, every logic cell effectively contains exactly one logical tree of nested Python lexical blocks, and every logic cell contains exactly one root enclosing Python lexical block that is the root of the logical tree in the cell. From mutually-exclusive predefined logic classes 190-194 and a parse tree of the root enclosing Python lexical block in a logic cell, logic classifier 317 inferentially classifies the logic cell as extraneous.

For example as discussed above, a logic cell that does not itself perform output may nonetheless be classified as output class 190. For example, step 703 may inferentially inspect the root Python lexical block in a logic cell to detect that the purpose of the logic cell is to display a diagnostic scatterplot, in which case step 703 infers that the logic cell is extraneous.

In step 704, code-generative LLM components 535-536 cooperatively and inferentially generate modified copy of original Python notebook 112 as discussed earlier herein and as follows. Steps 705-706 are sub-steps of step 704. Based on cell types of extraneous cells, step 705 excludes multiple extraneous cells from being represented in modified copy of original Python notebook 112. As discussed earlier herein, step 705 may exclude: a) all notebook cells whose cell type is markdown cell type 121 and b) some unreachable notebook cells whose cell type is logic cell type 122.

In step 706, function generator 535 inferentially generates and inserts new subroutine 161 into modified copy of original Python notebook 122 as discussed earlier herein.

### 8.0 Example Inferrentially Generative Software Development Lifecycle (SDLC) Process

FIG. 8 is a flow diagram that depicts an example process that computer 100 may perform to cause some stages of agents pipeline 200 to cooperatively test, commit, and deploy modified copy of original Python notebook 112 according to a software development lifecycle (SDLC).

For each logic cell that is not extraneous, step 801 inferentially generates metadata. Dataflow analyzer 213 may be upstream (i.e. provide data to) LLM components 214 and/or 317 that infer a global ordering of execution of logic cells in original Python notebook 111. In step 801 in ways discussed earlier herein: a) either of LLM components 214 and/or 317 may generatively infer metadata, for a logic cell, that includes an execution sequence number of the logic cell; or b) dataflow analyzer 213 may generatively infer metadata, for a logic cell, that indicates a dependency between the logic cell and another logic cell.

In modified copy of original Python notebook 112 in step 802, docstring generator 538 inferentially generates many docstrings that each is a documentation descriptor that contains natural language (NL) as discussed earlier herein.

As discussed earlier herein, computer 100 can retrieve a previous version or commit a next version of modified copy of Python notebook 112 in a first version control repository, even if computer 100 has no commit privilege or no access to a second version control repository that contains original Python notebook 111. That is, Python notebooks 111-112 have separate respective version control repositories. Each of Python notebooks 111-112 has its own SDLC, and these two lifecycles are tightly coupled as follows.

As discussed earlier: a) the processes of FIGS. 7-8 may be combined into a combined process; and b) the combined process may be interactively initiated (e.g. by a button press). This interactive trigger is a transitional time in the SDLC of Python notebooks 111-112. Opensource git is an implementation of a version control repository, and a git-based embodiment of an SDLC herein issues git commands in the following relative ordering: fetch, pull, and push.

As discussed later herein, computer 100 contains a version pull agent. Regardless of which git command, the version pull agent issues a git command by sequentially performing: 1) generate the command, 2) send the command to the version control repository, and 3) receive a git response back from the repository.

Each of Python notebooks 111-112 has an SDLC that includes behavior, such as a git fetch, that already occurred before the interactive trigger. Thus even before the interactive trigger, computer 100 often already retrieved the latest committed (i.e. pushed) versions of Python notebooks 111-112. Although git push and git commit are two distinct commands, however due to complexity of the git lifecycle, multiple git commands are needed to upload a new version into a version control repository. Thus herein: a) commit is an activity that may entail multiple git commands; b) commit is based on pull and push commands; c) no commit is implemented as a git commit command; and d) committed means pushed.

Herein for any Python notebook: a) the latest committed (i.e. pushed) version may be referred to as the previous version; and b) the uncommitted version may be referred to as the next version or the new version.

As discussed earlier herein, each version of modified copy of Python notebook 112 is a set of Python scripts. In step 803, test generators 641 and 644 infer boundary conditions for the previous version of that Python script. For example to prevent division by zero, the previous version of modified copy of Python notebook 112 may contain an if statement from which a boundary condition may be inferred.

In, step 804, test generators 641 and 644 inferentially generate differential tests that compare behavior of the next version of modified copy of Python notebook 112 to behavior of the previous version as discussed earlier herein, and these differential tests exercise both sides (i.e. condition is true and condition is false) of each boundary condition. In successful step 805, all generated differential tests execute and pass.

Subsequent steps 806-809 occur only if step 805 succeeds (i.e. no generated test fails). As discussed earlier herein: a) each of four agents 241-244 is a stage in a sequence of four stages in agents pipeline 200. The pipeline of an embodiment that supports FIG. 8 also contains an additional fifth stage that is an additional fifth agent (not shown in FIGs. herein), referred to herein as a version pull agent, that can commit the next version of modified copy of Python notebook 112.

In a git-based embodiment, herein: a) git pull is a command, not a request, and does not contain NL; b) a pull request is not a command and instead is a social (i.e. organizational) request that contains NL; and c) the relative ordering is git pull command, then git push command, and then pull request. Herein, committing a next version of modified copy of Python notebook 112 into the version control repository entails merging that is triphasic, with git pull, git push, and pull request being the three sequential phases of a merge. In an organizationally unmanaged embodiment that does not need external approval, the pull request phase is unimplemented. A pull request is discussed later below.

After step 805 succeeds, the version pull agent issues a git pull (i.e. not a pull request) before step 806. For example: a) multiple software developers may race to commit new versions of original Python notebook 111; b) some (e.g. most) of the developers do not cause the interactive trigger and do not commit new versions of modified copy of original Python notebook 112; and thus c) original Python notebook 111 likely has more previously committed versions than modified copy of original Python notebook 112 has. In another example, multiple software developers race to commit new versions of modified copy of original Python notebook 112.

The following are examples of staleness (i.e. incoherence between versions): a) modified copy of original Python notebook 112 may be missing some functionality (e.g. bug fixes) that the latest committed version of modified copy of original Python notebook 112 has; or b) modified copy of original Python notebook 112 may have a conflict (e.g. conflicting changes to a same Python statement) with the latest committed version of modified copy of original Python notebook 112. In one example, the git fetch retrieved a version of modified copy of original Python notebook 112 that, due to racing developers, has now become stale.

For querying and retrieval of repository content or repository metadata by computer 100, the version control repository contains metadata that indicates the version history of modified copy of original Python notebook 112, including a sequence of versions and their respective labels (i.e. identifiers). Herein: a) the previous version may be referred to as the parent version; and b) in the sequence of versions, the parent version follows and is adjacent to an even older version referred to as the grandparent version.

As discussed above, the git fetch command already retrieved the latest committed version from the version control repository, and that version is referred to herein as the base version. Staleness is when the base version is no longer the latest committed version (i.e. due to a racing commit by another developer). In response to the version pull agent sending a git pull command, the version pull agent might receive a pull response that indicates that modified copy of original Python notebook 112 is not stale. Otherwise, the pull response contains a respective text patch for each stale file (i.e. module) in modified copy of original Python notebook 112.

For a stale file in computer 100, the text patch contains textual differences between the parent (i.e. latest committed) and grandparent (i.e. base) versions. Without modifying content in the version control repository, the version pull agent modifies the next version of modified copy of Python notebook 112 by applying the text patch to the stale file. If automatically applying the text patch fails, then there is a version conflict that should be manually reconciled.

The version pull agent may contain the following multiple LLM components. In step 806, an LLM component in the version pull agent inferentially generates descriptive NL that summarizes: a) semantic differences between the previous and next versions of modified copy of Python notebook 112 and/or b) motivations for those differences. Into the version control repository in step 806, the version pull agent commits (i.e. pushes) the next version of modified copy of Python notebook 112, including the generated descriptive NL. As discussed earlier herein, modified copy of Python notebook 112 may consist of multiple generated Python modules (i.e. files). If the previous and next versions of a file are identical, then the file is excluded from the commit by step 806.

Because a pull request is a social request seeking approval from multiple people that may, for example, belong to a different organization or team, the accuracy of both grammar (i.e. syntax) and semantics in descriptive NL sentences or paragraphs in the pull request might determine the efficacy (i.e. acceptance or rejection) of the pull request and thus might determine final acceptance or rejection of the next version of modified copy of Python notebook 112.

In step 807, an LLM component in the version pull agent inferentially generates a pull request that contains natural language that summarizes: a) a software defect that is fixed by the next version of modified copy of Python notebook 112 and b) semantic differences between new and previous versions of a Python script in modified copy of Python notebook 112. Step 807 displays to the user: a) the inferentially generated pull request and b) a text patch that indicates textual differences between the previous and next versions of modified copy of Python notebook 112. Only if the user interactively approves the generated pull request, the request is sent for manual approval.

Step 808 occurs only if the pull request is manually approved by someone other than the developer who caused the interactive trigger discussed earlier herein. Thus, an approver and the developer are at least two people who should agree that the next version of modified copy of Python notebook 112 is ready for deployment. Otherwise, deployment step 808 does not occur. In an embodiment, manual approval entails manually updating a webpage that tracks the status of the pull request. Computer 100 monitors the status and initiates step 808 when the status indicates approval.

Into service, step 808 deploys and executes modified copy of Python notebook 112 on a remote computer in a production environment. In an embodiment, step 808 uses a continuous integration (CI) or continuous deployment (CD) tool to deploy modified copy of Python notebook 112.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

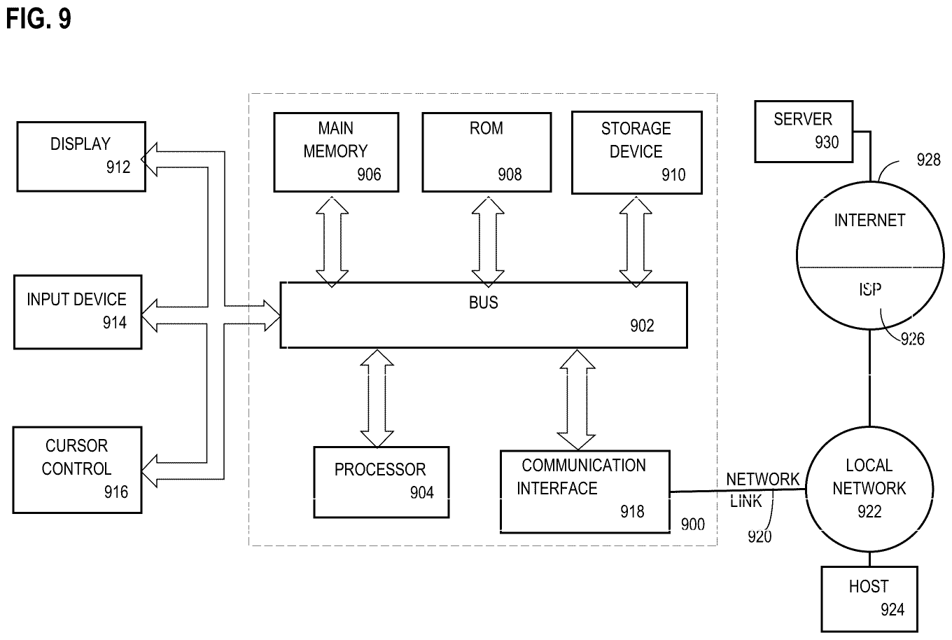

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet”928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### Software Overview

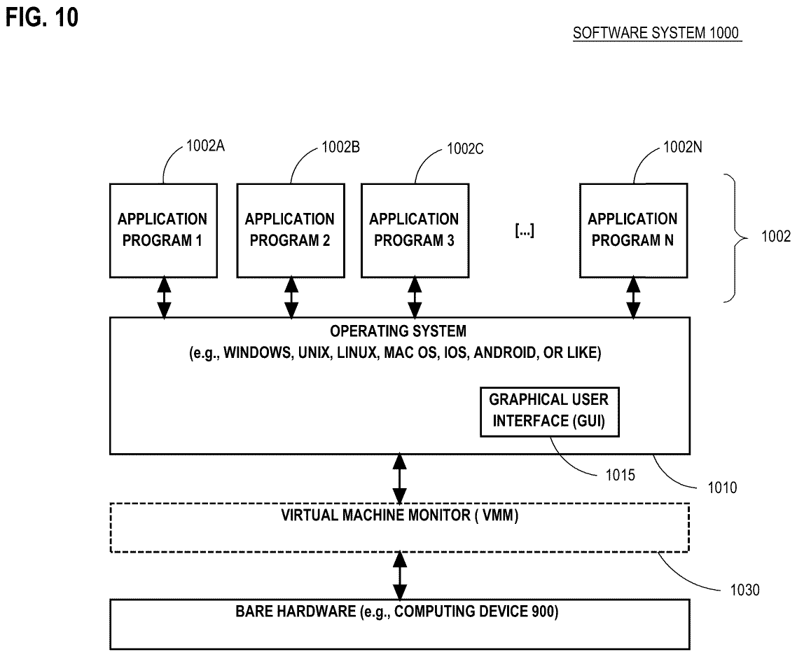

FIG. 10 is a block diagram of a basic software system 1000 that may be employed for controlling the operation of computing system 900. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computing system 900. Software system 1000, which may be stored in system memory (RAM) 906 and on fixed storage (e.g., hard disk or flash memory) 910, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C . . . 1002N, may be “loaded” (e.g., transferred from fixed storage 910 into memory 906) for execution by the system 1000. The applications or other software intended for use on computer system 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 904) of computer system 900. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 900.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 900 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C #, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 25;2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
inferentially detecting, by a large language model (LLM), a plurality of extraneous cells in an original sequence of cells in an original Python notebook; and
inferentially generating, by the LLM, a modified copy of the original Python notebook, including:
excluding, for each extraneous cell in the plurality of extraneous cells in the original sequence of cells, the extraneous cell based on a cell type of the extraneous cell, and
inserting a new subroutine into the modified copy of the original Python notebook;
wherein the method is initiated from a Python kernel in a computer.

2. The method of claim 1 wherein:
the original Python notebook contain JavaScript object notation (JSON);
the modified copy of the original Python notebook does not contain JSON;
the modified copy of the original Python notebook contains Python logic that implements a magic command from the original Python notebook.

3. The method of claim 1 wherein:
the original Python notebook is not a Python script;
the modified copy of the original Python notebook is a new version of the Python script;
the method further comprises the LLM inferentially generating a plurality of differential tests that compare behavior of the new version of the Python script to behavior of a previous version of the Python script.

4. The method of claim 3 wherein:
the previous version of the Python script comprises a software defect;
the method further comprises:
passing the plurality of differential tests;
the LLM inferentially generating natural language that summarizes: the software defect and a semantic difference between the new version of the Python script and the previous version of the Python script;
performing, in response to a user interaction after said passing, at least one action selected from a group consisting of:
execution of the new version of the Python script on a remote computer that is not said computer and
persistence of the natural language and the new version of the Python script into a version control repository.

5. The method of claim 3 wherein said inferentially generating the plurality of differential tests comprises inferring a boundary condition for the previous version of the Python script.

6. The method of claim 1 wherein:
a plurality of cell types includes a markdown cell type and a logic cell type;
the cell type of a particular extraneous cell in the plurality of extraneous cells is not the logic cell type.

7. The method of claim 1 wherein:
a plurality of cell types includes a markdown cell type and a logic cell type;
the cell type of a particular extraneous cell in the plurality of extraneous cells is the logic cell type;
the particular extraneous cell contains a Python lexical block;
said excluding is based on a parse tree of the Python lexical block.

8. The method of claim 1 wherein:
a plurality of cell types includes a markdown cell type and a logic cell type;
a plurality of logic classes includes a data load class, a preprocess class, a model train class, and a model validation class;
the cell type of a particular extraneous cell in the plurality of extraneous cells is the logic cell type;
the particular extraneous cell contains a Python lexical block;
the method further comprises inferentially classifying, from the plurality of logic classes, based on a parse tree of the Python lexical block, the particular extraneous cell;
said excluding is based on a logic class of the particular extraneous cell.

9. The method of claim 1 wherein:
the method further comprises detecting a match of a regular expression to text in a cell in the original sequence of cells;
said inferentially classifying is based on said match of the regular expression.

10. The method of claim 1 wherein:
the original sequence of cells in the original Python notebook contains a plurality of logic cells;
the cell type of each logic cell in the plurality of logic cells is the logic cell type;
said inferentially generating comprises for each logic cell of multiple logic cells in the plurality of logic cells inferentially generating metadata that indicates at least one selected from a group consisting of:
an execution sequence number of the logic cell within the plurality of logic cells, and
a dependency between the logic cell and an other logic cell in the plurality of logic cells.

11. The method of claim 1 wherein said inferentially generating comprises in the modified copy of the original Python notebook, the LLM inferentially generating a plurality of documentation descriptors that contain natural language.

12. The method of claim 1 performed in response to an interaction from a user.

13. One or more non-transitory computer-readable media storing instructions that, when executed by one or more processors, cause:
inferentially detecting, by a large language model (LLM), a plurality of extraneous cells in an original sequence of cells in an original Python notebook; and
inferentially generating, by the LLM, a modified copy of the original Python notebook, including:
excluding, for each extraneous cell in the plurality of extraneous cells in the original sequence of cells, the extraneous cell based on a cell type of the extraneous cell, and
inserting a new subroutine into the modified copy of the original Python notebook.

14. The one or more non-transitory computer-readable media of claim 13 wherein:
the original Python notebook contain JavaScript object notation (JSON);
the modified copy of the original Python notebook does not contain JSON;
the modified copy of the original Python notebook contains Python logic that implements a magic command from the original Python notebook.

15. The one or more non-transitory computer-readable media of claim 13 wherein:
the original Python notebook is not a Python script;
the modified copy of the original Python notebook is a new version of the Python script;
the instructions further cause the LLM inferentially generating a plurality of differential tests that compare behavior of the new version of the Python script to behavior of a previous version of the Python script.

16. The one or more non-transitory computer-readable media of claim 13 wherein:
a plurality of cell types includes a markdown cell type and a logic cell type;
the cell type of a particular extraneous cell in the plurality of extraneous cells is not the logic cell type.

17. The one or more non-transitory computer-readable media of claim 13 wherein:
a plurality of cell types includes a markdown cell type and a logic cell type;
the cell type of a particular extraneous cell in the plurality of extraneous cells is the logic cell type;
the particular extraneous cell contains a Python lexical block;
said excluding is based on a parse tree of the Python lexical block.

18. The one or more non-transitory computer-readable media of claim 13 wherein:
a plurality of cell types includes a markdown cell type and a logic cell type;
a plurality of logic classes includes a data load class, a preprocess class, a model train class, and a model validation class;
the cell type of a particular extraneous cell in the plurality of extraneous cells is the logic cell type;
the particular extraneous cell contains a Python lexical block;
the instructions further cause inferentially classifying, from the plurality of logic classes, based on a parse tree of the Python lexical block, the particular extraneous cell;
said excluding is based on a logic class of the particular extraneous cell.

19. The one or more non-transitory computer-readable media of claim 13 wherein:
the instructions further cause detecting a match of a regular expression to text in a cell in the original sequence of cells;
said inferentially classifying is based on said match of the regular expression.

20. The one or more non-transitory computer-readable media of claim 13 wherein:
the original sequence of cells in the original Python notebook contains a plurality of logic cells;
the cell type of each logic cell in the plurality of logic cells is the logic cell type;
said inferentially generating comprises for each logic cell of multiple logic cells in the plurality of logic cells inferentially generating metadata that indicates at least one selected from a group consisting of:
an execution sequence number of the logic cell within the plurality of logic cells, and
a dependency between the logic cell and an other logic cell in the plurality of logic cells.
